(19) United States
(12) Patent Application Publication
(10) Pub. No.: US 2017/0228937 A1
(43) Pub. Date: Aug. 10, 2017

(54) METHOD AND APPARATUS FOR RENDERING A LOCATION-BASED USER INTERFACE

(71) Applicant: Nokia Technologies Oy, Espoo (FI)

(72) Inventors: David Joseph MURPHY, Helsinki (FI); Brenda CASTRO, Helsinki (FI)

(21) Appl. No.: 15/489,293

(22) Filed: Apr. 17, 2017

Related U.S. Application Data
(63) Continuation of application No. 12/780,913, filed on May 16, 2010, now abandoned.

(51) Int. Cl. G06T 19/00; G06T 5/00; H04L 29/08; G06F 3/0481

(52) U.S. Cl. CPC G06T 19/006; G06F 3/04815; G06T 5/002; H04L 67/18; G06T 2200/24

(57) ABSTRACT

An approach is provided for enabling a pleasing lightweight transition between two more complete renderings of content associated with a location based service. A device is caused to present the first rendering of a graphical user interface based on location information of a three-dimensional model or models, panoramic image data, etc. corresponding to the starting location information. A change in rendering location is caused, leading to a series of transition renderings based in part on models and possibly image data associated with the intermediate locations, before finally the device presents the destination rendering similar to the starting rendering. The transition renderings provide a pleasing transition, which also allows the device time to fetch and process the heavier data associated with the final rendering.

### CROSS REFERENCE TO RELATED APPLICATIONS

This application is a continuation of U.S. patent application Ser. No. 12/780,913, filed May 16, 2010, titled “Method and Apparatus for Rendering a Location-Based User Interface”, the entire disclosure of which is hereby incorporated by reference herein.

### BACKGROUND

Computing devices (e.g., mobile devices, personal computers, terminals, etc.) are rapidly becoming the medium of choice for today's tech-savvy, content driven user. It is noted that modern devices can feature lavish graphical user interfaces (GUIs) for supporting sophisticated visual applications. GUIs support applications for displaying media, presenting internet content, enabling social communication and interaction, reviewing images or photos and other visually oriented tasks. Some devices can even execute real-time location-based applications and services that enable a user to display panoramic images via the GUI that are representative of the user's current environment and/or another remote environment. Hence, when it comes to visually oriented applications, the overall quality of the user experience depends to much an extent on the device's ability to readily present richly detailed, high-resolution images to the GUI. Unfortunately, the quality of the experience is inhibited when the images are slowly, or at best progressively rendered to the GUI. Moreover, location-based services relying on such high-resolution detailed imagery are less compelling for the user when the image intended to depict a location does not sufficiently match the real-time appearance of the location.

### SOME EXAMPLE EMBODIMENTS

Therefore, there is a need for an approach to rendering images to a graphical user interface of a device for fulfillment of a location-based service.

According to one embodiment, a method comprises receiving a request, at a device, to render a user interface of a location-based service, the request including location information. The method also comprises causing, at least in part, presentation of a first rendering in the user interface based, at least in part, on a three-dimensional model corresponding to the location information. The method further comprises causing, at least in part, presentation of a second rendering in the user interface based, at least in part, on image data associated with the location information.

According to another embodiment, an apparatus comprises at least one processor. The apparatus also comprises at least one memory including computer program code for one or more computer programs, the at least one memory and the computer program code configured to, with the at least one processor, receive a request, at a device, to render a user interface of a location-based services, the request including location information. The apparatus is further caused to present a first rendering in the user interface based, at least in part, on a three-dimensional model corresponding to the location information. The apparatus is further caused to present a second rendering in the user interface based, at least in part, on image data associated with the location information.

According to another embodiment, a computer-readable storage medium carrying one or more sequences of one or more instructions which, when executed by one or more processors, cause an apparatus to receive a request, at a device, to render a user interface of a location-based services, the request including location information. The apparatus is also caused to present a first rendering in the user interface based, at least in part, on a three-dimensional model corresponding to the location information. The apparatus is further caused to present a second rendering in the user interface based, at least in part, on image data associated with the location information.

According to another embodiment, an apparatus comprises means for receiving a request, at a device, to render a user interface of a location-based service, the request including location information. The apparatus also comprises means for causing, at least in part, presentation of a first rendering in the user interface based, at least in part, on a three-dimensional model corresponding to the location information. The method further comprises means for causing, at least in part, presentation of a second rendering in the user interface based, at least in part, on image data associated with the location information.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram a system capable of rendering images to a graphical user interface of a device for fulfillment of a location-based service, according to one embodiment;

FIG. 2 is a diagram of the components of user equipment, according to one embodiment;

FIG. 3 is a flowchart of a high-level process for rendering images to a graphical user interface of a device for fulfillment of a location-based service, according to one embodiment;

FIGS. 4A-4E are diagrams of user interfaces utilized in the processes of FIG. 3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for rendering images to a graphical user interface of a device—i.e., mobile devices—for fulfillment of a location-based service are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, “location information” pertains to any data that is useful for indicating the current location, presence or orientation of a device, a user, an object or combination thereof relative to a known geographical point. With this in mind, location information can be determined in various ways, including but not limited to, known global positioning system (GPS) calculation techniques, cell phone triangulation, usage of various location-based sensors resident upon or within proximity to a mobile device, etc. Sensors useful for detecting location information may include, but is not limited to a gyroscope, a directional heading or compass detection sensor, tilt angle sensor, spatiotemporal detection sensor, etc., all of which can be used to define what location should be rendered to a graphical user interface (GUI) in the context of a location-based services. In relation to location information, “context information” for providing contextual details pertaining to the current environment of the user or mobile device can be sensed as well. This may include details such as current weather conditions, time of day, traffic conditions, etc., all of which can be rendered to a GUI with respect to a location-based services.

As suggested above, location information can be determined and/or calculated with respect to a “location-based service.” Location based services include any service or application for rendering visual feedback to a graphical user interface (GUI) of a device based, at least in part, on the determined location information. Exemplary location based services may support applications for rendering visual depictions of maps, routes, waypoints, position data, etc. in connection with a global positioning system application. As another example, location based services may be called upon to support augmented reality (AR) or mixed reality (MR) applications. AR allows a user's view of the real world, as rendered to a GUI, to be overlaid with additional visual information, while MR allows for the merging of real and virtual worlds to produce visualizations and new environments to the GUI of a device. In MR, the physical world is used to depict a natural and precise virtual environment that can also be used in AR. Thus, MR can be a mix of reality, AR, virtual reality, or a combination thereof.

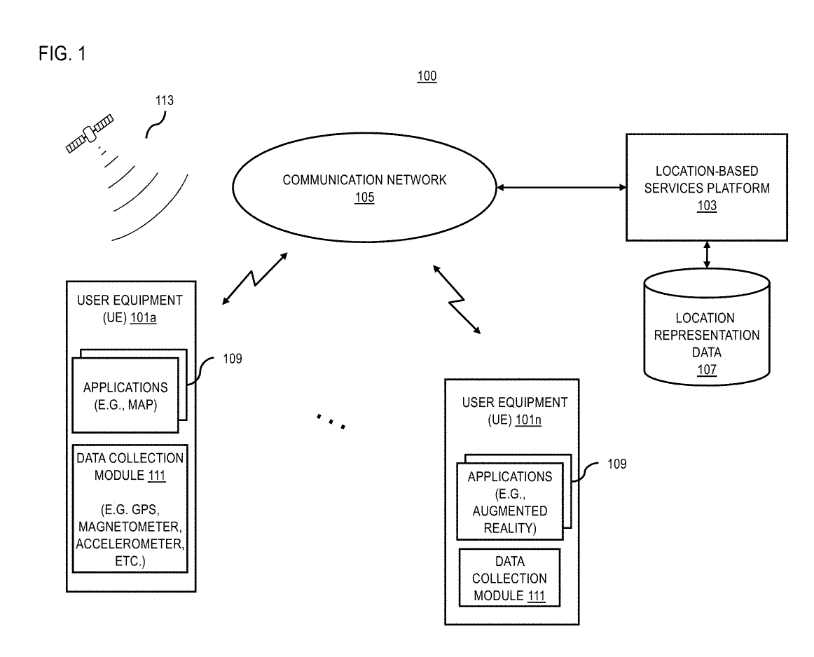

FIG. 1 is a diagram of a system capable of rendering images to a graphical user interface of a device for fulfillment of a location-based service, according to one embodiment. It is noted that mobile devices and computing devices in general rely heavily upon the use of visual elements as rendered to the GUI. This is especially the case in AR or MR applications, wherein known location information can be used to render visual depictions of real world elements to the user's graphical user interface. In certain instances, this involves the use of high resolution images to depict known elements associated with the determined location—e.g., of buildings, landmarks, public settings. Unfortunately, the time required to load such high resolution images can be slow, or at best, progressive. Recognizing this, some applications enable a blur effect, where the amount of blur decreases as loading progresses. Other applications make use of a progress bar or other icon to provide the user with some sense of the extent of the loading process. Regardless, the user's ability to readily experience the visual representations they desire relative to their particular application or need is delayed.

Once the images are rendered to a GUI in connection with a location-based services or application, the user experience is limited when the image loaded to represent a current scenery, environment or location of interest differs from what the user sees at the present moment. For example, an image of a particular location when taken during the evening time is not easily recognizable by the user if they are presently located at that location during the morning. As yet another example, an image of a landmark as captured during the winter time during a period of snowfall, may not be recognizable when viewed in current/real-time during the summertime. In general, images rendered to a GUI in connection with a location-based services or corresponding location information may not be easily recognized by the user when people, objects or weather conditions depicted in the image differ from reality.

To address these problems, a system 100 of FIG. 1 introduces the capability to render content based on an object model representation of a location to a graphical user interface in association with an image representation of said location. In particular, a dimensional object model is presented to the GUI in lieu of or until a representative image for that location can be loaded along with, in addition to or atop of the dimensional object model. In one embodiment, the object model can be a three dimensional representation of a physical object in the real world or physical environment associated with the location. In certain embodiments, the representation or model of the physical object can be free of textures to reduce loading and/or rendering times. In other instances, the object model can be a corresponding virtual object in a virtual reality world (e.g., to support AR or MR applications). In yet another embodiment, the representation can be a two dimensional scene extracted from a three dimensional model or from graphical information (e.g., contrast, saturation, etc.) of an image (e.g., a panorama) taken from a certain location.

In one embodiment, user equipment 101a-101n of FIG. 1 can present the GUI to users. In certain embodiments, the processing and/or rendering of the images may occur on the UE 101. In other embodiments, some or all of the processing may occur on one or more location-based services platforms 103 that provide one or more location-based services based, at least in part, on location information. In certain embodiments, a location-based service is a service that can provide information and/or entertainment based, at least in part, on a geographical position of the UE 101. Examples of location-based services include navigation, map services, local searching, remote discovery, remote searching, AR, mobile directory services, etc.

The UE 101 and the location-based services platform 103 can communicate via a communication network 105. In certain embodiments, the location-based services platform 103 may additionally include location representation data 107, which may include media (e.g., audio, video) or image data (e.g., panoramic images, photographs, etc.) associated with a determined location (e.g., location information specifying coordinates in metadata). In addition, the location representation data 107 can also include map information. Map information may include maps, satellite images, street and path information, point of interest (POI) information, signing information associated with maps, objects and structures associated with the maps, information about people and the locations of people, coordinate information associated with the information, etc., or a combination thereof. A POI can be a specific point location that a person may, for instance, find interesting or useful. Examples of POIs can include an airport, a bakery, a dam, a landmark, a restaurant, a hotel, a building, a park, the location of a person, or any point interesting, useful, or significant in some way.

In certain embodiments, the location representation data 107 can also include 3D object models corresponding to the location information. The 3D models represent an approximation or likeness of the physical objects associated with a particular location—i.e., streets, buildings, landmarks, etc. of an area. Models can be positioned in virtually any angle or perspective for display on the UE 101. The 3D model can include one or more 3D object models (e.g., models of buildings, trees, signs, billboards, lampposts, landmarks, statues, sites, sceneries, etc.). These 3D object models can further comprise one or more other component object models (e.g., a building can include four wall component models; a sign can include a sign component model and a post component model, etc.). Generally, object models represent a given location or objects associated therewith with much less detail. For example, a typical model of a building may include elements sufficient to generate a 3D outline (e.g., skyline view) of the building but not the many topical, facial or other external details and features of said building (e.g., windows, masonry elements, colours, entryways). In contrast, a high-resolution or detailed image of the building maintained as location representation data 107 will feature such detail. It is noted that the location representation data 107 will include at least one corresponding 3D model for one or more images maintained in association with a given location.

Hence, any image data useful for generating a representation based, at least in part on location information relative to the UE 101, an object or user, can be stored as location representation data 107. It is noted that the location representation data 107, particularly in the form of images, can be vector based so as to enable more efficient image loading and adaptation relative to a particular application need. Vector based images are constructed using a mathematical formula that factors the exact points, lines, curves, and shapes or polygon(s) of an original image to a GUI based on the screen resolution. Hence, vector images can accommodate varying resolution needs and thus be readily loaded and rendered to a GUI. In certain embodiments, the location representation data 107 can be broken up into one or more databases, or in other embodiments, distributed and shared amongst differing UE 101.

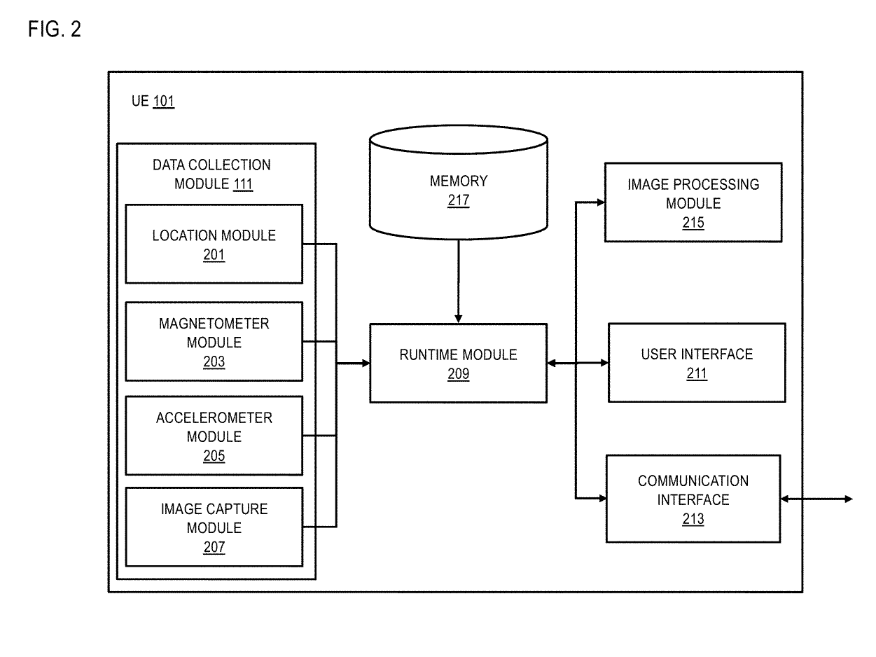

The user may use an application 109 (e.g., an augmented reality application, mixed reality application, a map application, a location-based services application, etc.) resident on or accessible by the UE 101 to provide content associated with determined location information. In this manner, the user may access the location-based services platform 103 via the application 109. So, for example, the application may be a map generation application through which map data, building imagery and/or related 3D models may be accessed for presentment via the UE 101. Operable in connection with the application 109 is a data collection module 111. The data collection module 111, among other things, makes use of various more sensory devices/modules of the UE 101 for collecting and/or sensing location information relative to the UE 101, the user, objects associated therewith or a combination thereof. Once collected, the data collection module can relay location information to the calling application 109 so that specific content related to said location may be obtained from the location-based services platform 103. More regarding the operation of the data collection module 111 is presented later on in the description with respect to FIG. 2.

In certain embodiments, one or more GPS satellites 113 may be utilized in determining the location of the UE 101 in connection with one or more spatiotemporal or GPS transceivers of the data collection module 111. Further, the data collection module 111 may include an image capture module, which may include a digital camera or other means for generating real world images. These images can include one or more objects (e.g., a building, tree, sign, car, truck, etc.). Further, these images can be presented to the user via the GUI. The UE 101 can determine a location, an orientation, or a combination thereof for the UE 101 or user to present the content and/or to add additional content.

For example, the user may be presented a GUI including an image of a location. This image can be tied to the 3D world model (e.g., via a subset of the location representation data 107). The user may then select a portion or point on the GUI (e.g., using a touch enabled input). The UE 101 receives this input and determines a point on the 3D world model that is associated with the selected point. This determination can include the determination of an object model and a point on the object model and/or a component of the object model. The point can then be used as a reference or starting position for the content. Further, the exact point can be saved in a content data structure associated with the object model. This content data structure can include the point, an association to the object model, the content, the creator of the content, any permissions associated with the content, etc.

Permissions associated with the content can be assigned by the user, for example, the user may select that the user's UE 101 is the only device allowed to receive the content. In this scenario, the content may be stored on the user's UE 101 and/or as part of the world data 107 (e.g., by transmitting the content to the location-based services platform 103). Further, the permissions can be public, based on a key, a username and password authentication, based on whether the other users are part of a contact list of the user, or the like. In these scenarios, the UE 101 can transmit the content information and associated content to the location-based services platform 103 for storing as part of the world data 107 or in another database associated with the world data 107. As such, the UE 101 can cause, at least in part, storage of the association of the content and the point. In certain embodiments, content can be visual or audio information that can be created by the user or associated by the user to the point and/or object. Examples of content can include a drawing starting at the point, an image, a 3D object, an advertisement, text, comments to other content or objects, or the like.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the location-based services platform 103, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the location-based services platform 103 may interact according to a client-server model with the applications 109 of the UE 101. According to the client-server model, a client process sends a message including a request to a server process, and the server process responds by providing a service (e.g., augmented reality image processing, augmented reality image retrieval, messaging, 3D map retrieval, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 2 is a diagram of the components of user equipment, according to one embodiment. By way of example, a UE 101 includes one or more components for rendering content based on an object model representation of a location to a graphical user interface in association with an image representation of said location. It is contemplated that the functions of these components may be combined in one or more components or performed by other components of equivalent functionality. In this embodiment, the UE 101 includes a data collection module 111 that may include one or more location modules 201, magnetometer modules 203, accelerometer modules 205, image capture modules 207, the UE 101 can also include a runtime module 209 to coordinate use of other components of the UE 101, a user interface 211, a communication interface 213, an image processing module 215, and memory 217. An application 109 (e.g., the location-based services application) of the UE 101 can execute on the runtime module 209 utilizing the components of the UE 101.

As mentioned previously, the location module 201 can determine a user's location. The user's location can be determined by a triangulation system such as GPS, assisted GPs (A-GPS), Cell of Origin, or other location extrapolation technologies. Standard GPS and A-GPS systems can use satellites 113 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are embedded into metadata of captured media (e.g., images, video, etc.) or otherwise associated with the UE 101 by the application 109. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is embedded into the metadata of captured or streaming media or otherwise associated with the UE 101 (e.g., by including the information in a request to a location-based services platform 103) by the location-based services application 109. The request can be utilized to retrieve one or more objects and/or images associated with the location.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the location-based services application 109. In certain embodiments, the magnetometer module 203 and accelerometer module 205 can be means for ascertaining a perspective of a user. Further, the orientation in association with the user's location can be utilized to map one or more images (e.g., panoramic images and/or camera view images) to a 3D environment.

In one embodiment, the communication interface 213 can be used to communicate with a location-based services platform 103 or other UEs 101. Certain communications can be via methods such as an internet protocol, messaging (e.g., SMS, MMS, etc.), or any other communication method (e.g., via the communication network 105). In some examples, the UE 101 can send a request to the location-based services platform 103 via the communication interface 213. The location-based services platform 103 may then send a response back via the communication interface 213. In certain embodiments, location and/or orientation information is used to generate a request to the location-based services platform 103 for one or more images (e.g., panoramic images) of one or more objects, one or more map location information, a 3D map, etc.

The image capture module 207 can be connected to one or more media capture devices. The image capture module 207 can include optical sensors and circuitry that can convert optical images into a digital format. Examples of image capture modules 207 include cameras, camcorders, etc. Moreover, the image capture module 207 can process incoming data from the media capture devices. For example, the image capture module 207 can receive a video feed of information relating to a real world environment (e.g., while executing the location-based services application 109 via the runtime module 209). The image capture module 207 can capture one or more images from the information and/or sets of images (e.g., video). These images may be processed by the image processing module 215 to include content retrieved from a location-based services platform 103 or otherwise made available to the location-based services application 109 (e.g., via the memory 217). The image processing module 215 may be implemented via one or more processors, graphics processors, etc. In certain embodiments, the image capture module 207 can be a means for determining one or more images.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Moreover, the user interface 211 may be used to display maps, navigation information, camera images and streams, augmented reality application information, POIs, virtual reality map images, panoramic images, etc. from the memory 217 and/or received over the communication interface 213. Input can be via one or more methods such as voice input, textual input, typed input, typed touch-screen input, other touch-enabled input, etc. In certain embodiments, the user interface 211 and/or runtime module 209 can be means for causing rendering of content on one or more surfaces of an object model.

Further, the user interface 211 can additionally be utilized to add content, interact with content, manipulate content, or the like. The user interface may additionally be utilized to filter content from a presentation and/or select criteria. Moreover, the user interface may be used to manipulate objects. The user interface 211 can be utilized in causing presentation of images, such as a panoramic image, an AR image, an MR image, a virtual reality image, or a combination thereof. These images can be tied to a virtual environment mimicking or otherwise associated with the real world. Any suitable gear (e.g., a mobile device, augment reality glasses, projectors, etc.) can be used as the user interface 211. The user interface 211 may be considered a means for displaying and/or receiving input to communicate information associated with an application 109.

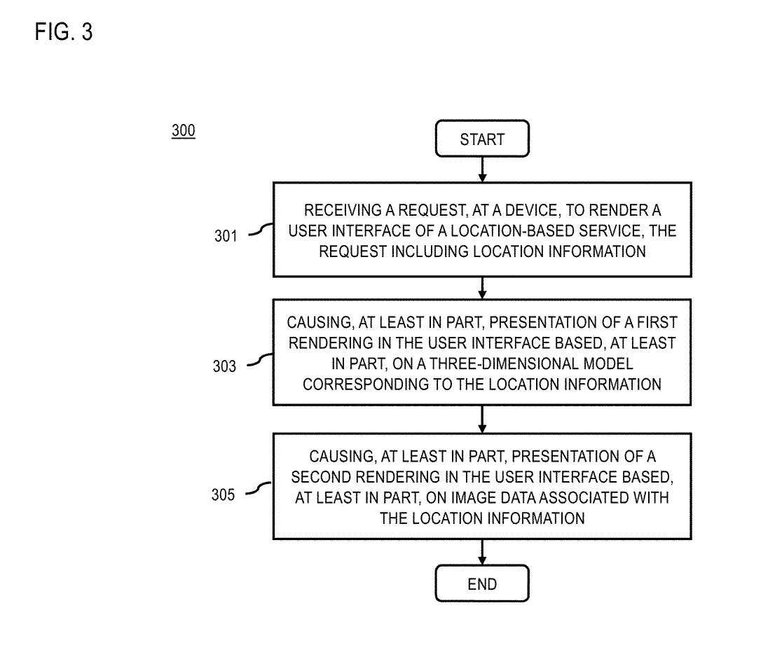

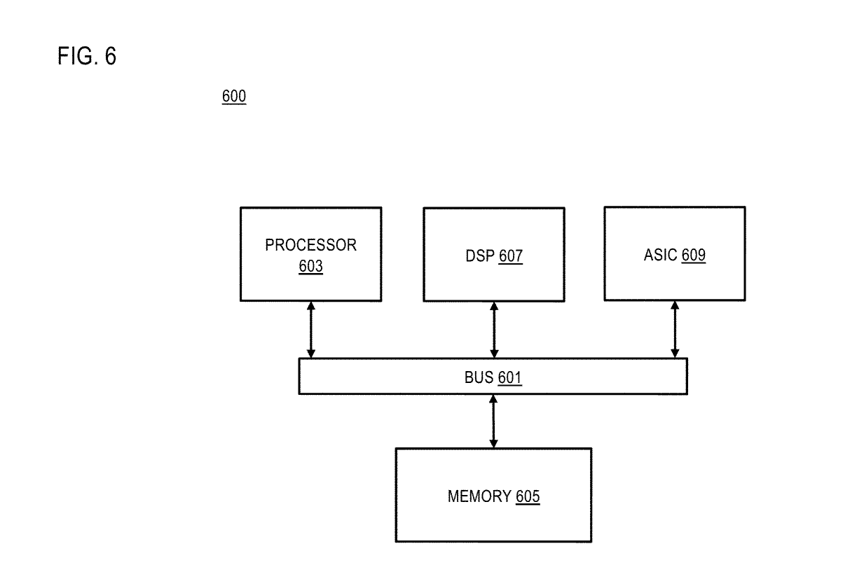

Turning now to FIG. 3, an exemplary flowchart depicting a high-level process for rendering images to a graphical user interface of a device for fulfillment of a location-based service is presented, according to one embodiment. In one embodiment, an application 109 performs the process 300 and is implemented in, for instance, a chip set including a processor and a memory as shown in FIG. 6. In addition or alternatively, all or a portion of the process 300 may be performed by the location-based services platform 103, another component of the UE 101, or another component available over the communication network 105. In a first step 301, a UE 101 receives a request to render a user interface of a location-based service to the GUI of the device. This request may be facilitated by or in response to the application 109 (e.g., an augmented reality application, mixed reality application, etc.) having access to the location-based services platform 103. The request may also include location information associated with the device (e.g., a UE 101), a user of the device, or the like. By way of example, the location information may be used as a location on which the user interface of the application 109 is based. For example, if the application 109 is an augmented reality application, the location information may be used to establish the viewpoint using a location, directional heading, and/or tilt angle specified as part of the location information. The viewpoint is then used as the basis for rendering a corresponding user interface.

It is noted that traditionally augmented reality applications and other applications providing similar location-based functions rely on detailed images and panoramas to depict a particularly location. However, these images can often comprise substantial amounts of data that can take a lengthy amount of time to download and render at the UE 101. This downloading and rendering time is based on, for instance, the bandwidth, computing power, memory, etc. of the rendering device, but can typically take several seconds to tens of seconds or more. Conventional solutions to this lag time for loading and/or rendering historically have included (1) providing a progress bar as the images are rendered and/or (2) progressively loading lower quality lighter weight images before loading the final detailed images (e.g., first loading a blurry low resolution picture before loading a clearer more detailed picture). However, these traditional approaches do not always provide a good user experience.

Accordingly, in the approach described herein and as another step 303 of the process 300, the application 109 is caused to present a first rendering in the user interface based, at least in part, on a three-dimensional model corresponding to the location information. As such, the 3D object module associated with the specified location information is viewable by the user via the devices GUI. In one embodiment, the first rendering is performed quickly based on lightweight (e.g., in terms of memory, processing, and/or bandwidth resources used) models. The model-based first rendering can provide, for instance, detailed high quality and high contrast images that can be more attractive and provide more information than a traditional progress bar or low quality image.

In addition, the application 109 can determine context information associated with the UE 101, a user of the device, or a combination thereof. By way of example, context information may include weather, time, date, season, holidays, activities, and the like, or any combination thereof. This context information can then be used as part of the first rendering. For example, if the context information indicates that the weather is sunny and the time of day is morning, the first rendering of the model can also depict sunny weather using lighting equivalent to what is available in a typical morning. If it is raining, rain can also be depicted in the rendering. In this way, the user is presented with a user interface (e.g., an augmented reality user interface or map) that more accurately reflects actual conditions at the scene, so that the user can more easily associate features depicted in the user interface with their real-world counterparts.

Then, as the higher quality images become available for presentation (e.g., after they have been retrieved from a service such as the location-based services platform 103), the application 109 can initiate another rendering. As shown in step 305, the application 109 is further caused to present, at least in part, a second rendering in the user interface of the location-based service based, at least in part, on image data associated with the location information. In one embodiment, the application 109 can determine a time (e.g., the time needed for downloading and rendering) associated with retrieving the image data for the second rendering and then cause, at least in part, a transition of the user interface from the first rendering to the second rendering based, at least in part, on the determined time. By way of example, the transition may occur gradually whereby the models of the first rendering are replaced or overlaid with the actual corresponding imagery. For instance, a 3D model of a building depicted in the first rendering of the user interface is replaced with the actual image of the image once that image is available.

In another embodiment, the context information may be used to determine the use, non-use, or delay of the second rendering (e.g., based on higher resolution images or textured three-dimensional graphics). For example, if the context information is related to a specific building or location in the user interface, the application 109 may render a higher resolution image of only that specific building. In this way, the application 109 can advantageously reduce the processing resources, bandwidth, and other like computing or networking resources by providing higher quality renderings only for those objects in the user interface that are contextually relevant.

In some embodiments, the transition from the first rendering to the second rendering may be determined by receiving an input from the user for manually selecting either the first rendering or the second rendering, and then presenting the user interface based on the user selection. In this way, if the user prefers the first rendering, the user can direct the application 109 to display only the first rendering or display the first rendering for a longer period of time.

In another embodiment, the selection of the image data for the second rendering can also be based on the context information. For example, if one or more images (e.g., panoramas) are available for a given location (e.g., a day view and a night view), the application 109 can use the context information can select the most representative images based on the context information. It is noted that complimentary images may be maintained as location representation data 107 for enabling such alternatives to be accommodated. In certain embodiments, the application 109 can also render elements of the context information over the image data. For example, if the weather is snowy and no snow images of the location are available, the application can retrieve the closest matching set of images and then render the snow (e.g., using 3D rendering) over the images. In this manner, various contextual nuances may still be appropriately rendered to the user interface respective to the give location.

In yet another embodiment, when the location information changes (e.g., when the UE 101 is moved to different) such that new imagery is needed to render the user interface, the application 109 can determine or detect (e.g., via location sensors) the change in location information. This change can then cause the application 109 to determine that the change causes a transition from one set of image data to another set of image data (e.g., to depict another location). The application 109 can then transition from the image-based rendering to a model-based rendering during the change, and then transition back to the image-based rendering of the new location once the corresponding new image data is retrieved.

In one example, the application 109 or the UE 101 is caused to present the first rendering of a graphical user interface based on location information of a three-dimensional model or models, panoramic image data, etc. corresponding to a starting or current location of the UE 101. A change in the rendering location is caused, which leads to one or more transition renderings based in part on models and possible image data associated with the intermediate locations, before the finally the device presents the destination rendering similar to the starting rendering (e.g., the high resolution image or textured 3D rendering). The transition renderings provide a pleasing transition, which also allows the device time to fetch and process the heavier data associated with the final rendering.

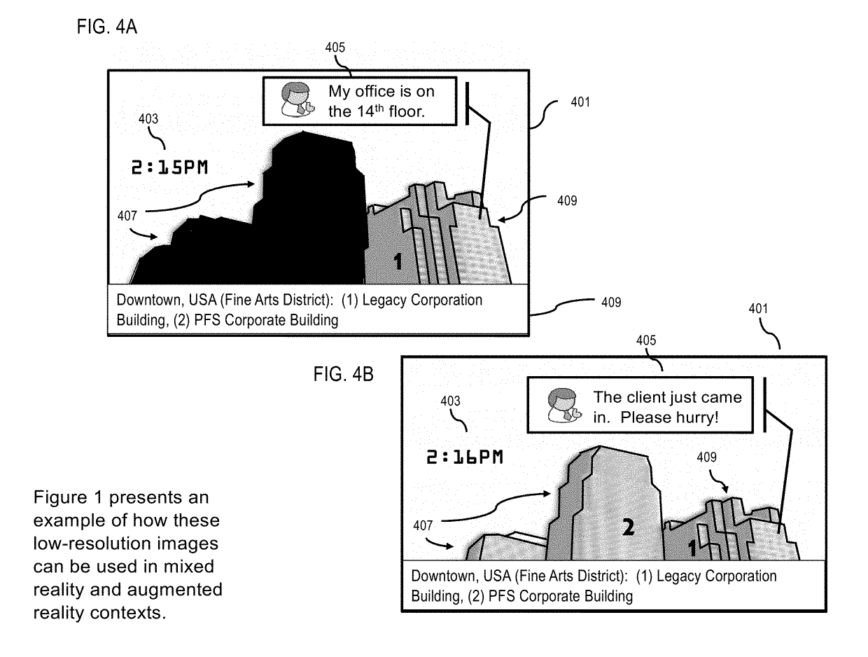

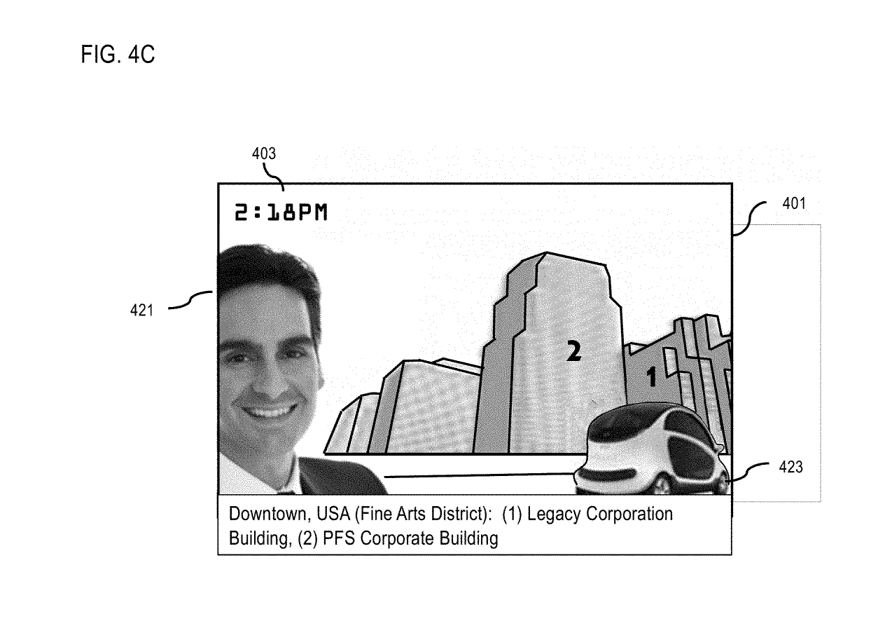

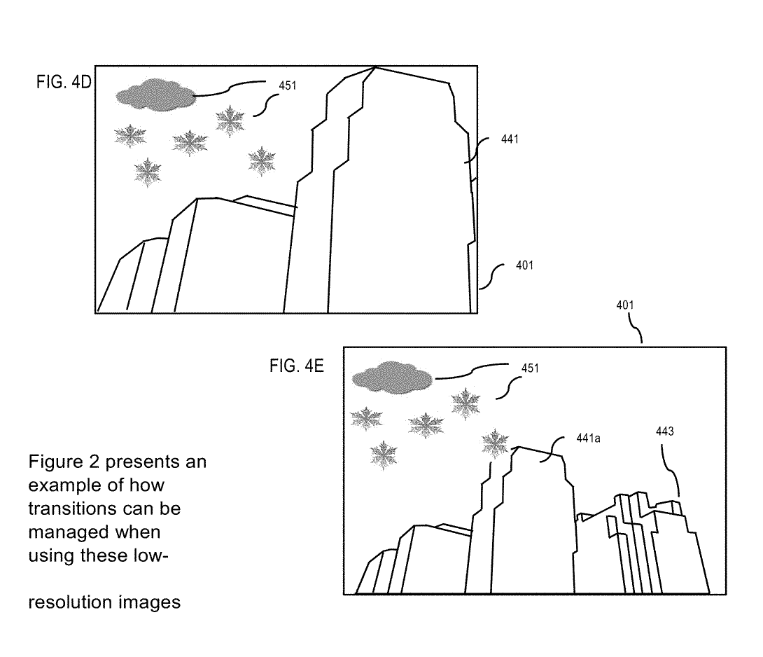

FIGS. 4A-4E are diagrams of user interfaces utilized in the processes of FIG. 3, according to various embodiments. FIGS. 4A and 4B are example interfaces depicting how low-resolution (or non-textured) 3D object models can be used in connection with high-resolution images in the context of an augmented reality (AR) or mixed reality (MR) application. FIGS. 4C-4D are exemplary interfaces depicting how transitions (in time and/or location) can be managed using low-resolution 3D object models associated with location information. The figures are presented from the perspective of exemplary use cases, described below.

In a first use case, a device user is walking to a meeting with an associate whose office is on the 14^{th} floor of the Legacy Corporation Building, located in Downtown, USA. Using a mobile device, the user invokes an AR application for enabling real-time chat to be facilitated via a device interface 401 concurrent with a location-based service. The AR application also facilitates implementation of a digital clock 403 to the user interface. Operable in connection with the AR application, the location based-service in this case includes a service for rendering visual depictions of elements, objects, etc. (407 and 409) representative of the user's real-time location and/or environment. In addition, the location based service generates a location information window for indicating to the user details regarding their current whereabouts and/or objects depicted in the graphical user interface (e.g., building names). Hence, the location-based service leverages location information as detected by the user's mobile device to access and then facilitate the rendering of imagery representative of the user's specific whereabouts in Downtown, USA. The AR application facilitates the overlay or mixed use of imagery associated with the digital clock 403 and chat application in connection with the location based imagery (e.g., buildings).

At 2:15 PM as represented by the digital clock 403, the user is within proximity of their intended destination, the Legacy Corporation Building 409, labeled by the location-based service and/or application as building 1. Building 1 is depicted as a full resolution 3D image 409 representation of the building, obtained as a result of accessing the location-based services platform. Hence, the image data was loaded onto an object model representative of the building to formulate or render a full resolution version or representation of the Legacy Corporation Building 409. In addition to the first building 1, however, a second building is labeled by the location-based service and/or application as building 2, namely the PFS Corporate Building. Based on the determined location information (e.g., orientation, acceleration, heading, bearing), this building is also within view of the user's and hence rendered to the user. Unlike the full resolution 3D image 409 depicting the Legacy Corporation Building, however, the PFS Corporate Building is simply a low-resolution object model representation of the building. The building in this example is depicted as an all black, featureless 3D representation. As such, the user is able to view a basic representation of the building in lieu of, or until the requisite high-resolution image data for the building can be adequately loaded to the user interface.

In FIG. 4B, as the user draws closer to their destination, the digital clock 403 is updated to represent the current time of 2:16 PM. A minute having elapsed, and the image data for the PFS Building having now been properly accessed from the location representation database 107 and loaded to the user interface 401, now each building 407 and 409 is shown in full 3D resolution. Hence, the low resolution image, based on a 3D model of the corresponding location or elements thereof is first rendered to the user interface. Upon loading of the requisite high resolution image of said location or element thereof, the high resolution imagery (second image representative of the building) is then rendered to the user interface. As noted in this example, rendering of the second image may be at a separate time than that of the first, thus ensuring that the user interface experience is still appropriately represented without having to wait upon loading of all imagery. As a further note, depending on application requirements, rendering of the second image may occur as an overlay atop the 3D model, wherein a vector image is us mapped accordingly to the model to enable sufficient resolution within the dimensions of the model. Alternative methods of rendering the images based on location information may also apply.

Still further, while image rendering is occurring, the user is able to engage in a chat session with a chat partner via a chat application 405 as facilitated by the AR application. While not shown, the user can also reply to the chat partner as well as perform other services (e.g., obtain directions, send a text message or e-mail, transfer a document, etc.). Of particular note is that this functional capability and user experience is facilitated without regard to the need for the device to load high resolution imagery for rendering an interactive user interface 401. In essence, the process as depicted with respect to FIG. 3 and in the foregoing use case provide examples of how the use of low resolution images in combination with, or in lieu of, high resolution imagery enables concurrent applications to be performed by the user without delays caused by lack of a suitable user interface.

Proceeding now to FIG. 4C, a depiction of the user interface 401 is shown with a mixture of live video or image capture elements in view or atop of the imagery as loaded with respect to FIG. 4B. In this example, at 2:18 PM as indicated on the digital clock 403, the mobile device user runs into another associate also scheduled to be at the same location (e.g., the Legacy Corporation Building). As the user waits to cross the street, the user decides to capture a live video image of the current scenery as imposed over the full resolution imagery of the buildings associated with the user's current location (buildings 1 and 2). This live capture includes a video footage of the associate 421 and a passing vehicle 423. Hence, mixed reality applications may also be appropriately supported in the same manner as described above for AR applications. While not shown, the video footage could still be presented to the user interface 401 even while the high resolution image access and loading process was underway through use of the 3D object model representations. Loading of the full resolution image would be triggered by completion of the loading of the high resolution image; while user operations via the interface was still able to be performed without interruption or wait.

In FIGS. 4D and 4E, it is assumed that a user is moving away from a set of buildings at a brisk pace. In this example, factors such as network availability, data access and availability, image size, device runtime and operating resources, and ultimately, loading time, all have an impact on the quality of data rendered to the user interface. If the user is also moving a relatively brisk speed—i.e., they are traveling in vehicle—then the location based service must be able to persistently update the images representative of the user's location to the user interface. With this in mind, a suitable means of handling such transitions includes the use again of the low resolution, featureless object models to depict the buildings during the transition process. As such, a first instance of representation of a building 441 is shown in FIG. 4D at a first point in time as rendered to the interface 401. This representation is based again on determined location information for the user, device or combination thereof.

A second instance of the building 441a, rendered to the interface 401 at a second point in time, is also depicted as a low resolution 3D object representation. Given the location information, a second building 443 is also rendered to the user interface 401. Hence, in this example, it is assumed that the elapsed time between the first and the second instance of renditions to the user interface 401 is relatively short, and certainly shorter than the period of time required for loading the high resolution image of the building. Hence, it is contemplated that the object model representations of objects and/or elements representative or associated with a determined location may be used in lieu of the full resolution images. No requisite loading of the high resolution images of the buildings need be invoked—i.e., this can be established as a user or system preference based on some of the considerations presented above (e.g., network factors, user acceleration).

Alternatively, the object model representations of objects and/or elements representative of are associated with a determined location may be used as the image is loading. Upon loading, the image is loaded to fit the current dimensions of the object model representation, such as by way of vector imaging. In this way, the use is still able to experience a location-based service without compromising a visual experience due to inadequate transitioning, slow image loading, etc. Still further, through use of the low resolution object models, the device can generally depict any location (buildings, scenery, landmarks, etc.) while still accounting for current weather, traffic, or other conditions. Such real-time conditions can be presented to the user interface 401 through usage of models, icons or graphical depictions, such as the snowflakes and cloud imagery 451 as shown in FIGS. 4D and 4E. This capability is enabled through reliance, for example, upon context information pertaining to the weather, time of day, etc. If necessary, the system can also render the snowflakes on top of the panoramic pictures to make the scene presented in the UI more closely match actual conditions if no closely matching images are available.

Ultimately, the system as presented herein enables a user device to quickly render a scene using models while waiting for download panoramic pictures to complete in the background. The rendering using the models can then transition to showing the real world images once the downloading is complete. This way the user does not have to wait for everything to download before seeing a picture or to view a lower quality picture before higher quality versions are downloaded.

The processes described herein for rendering images to a graphical user interface of a device for fulfillment of a location-based service may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

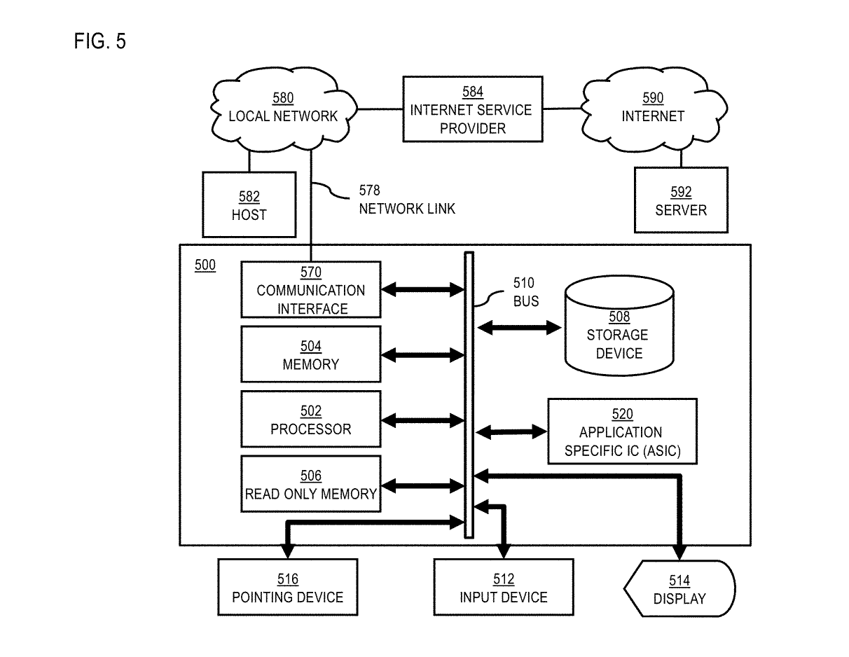

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to render images to a graphical user interface of a device for fulfillment of a location-based service as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of rendering images to a graphical user interface of a device for fulfillment of a location-based service.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to rendering images to a graphical user interface of a device for fulfillment of a location-based service. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for rendering images to a graphical user interface of a device for fulfillment of a location-based service. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for rendering images to a graphical user interface of a device for fulfillment of a location-based service, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for rendering images to a graphical user interface of a device for fulfillment of a location-based service to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to render images to a graphical user interface of a device for fulfillment of a location-based service as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of services. Chip set or chip 600, or a portion thereof, constitutes a means for performing one or more steps of rendering images to a graphical user interface of a device for fulfillment of a location-based service.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to render images to a graphical user interface of a device for fulfillment of a location-based service. The memory 605 also stores the data associated with or generated by the execution of the inventive steps.

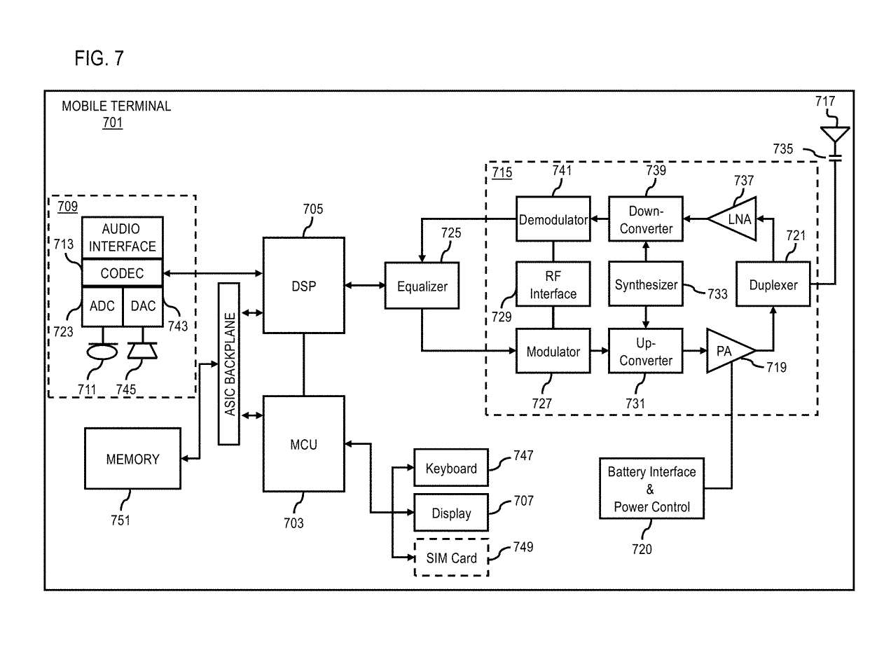

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of rendering images to a graphical user interface of a device for fulfillment of a location-based service. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of rendering images to a graphical user interface of a device for fulfillment of a location-based service. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to render images to a graphical user interface of a device for fulfillment of a location-based service. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. (canceled)

2. A method comprising:
receiving, at a device, a request to render a user interface of a real world image from a location-based service, the request including location information;
determining context information associated with the device, a user of the device, or a combination thereof, wherein the context information includes real-time weather, traffic, or a combination thereof at a current location of the device;
initiating a presentation of a first rendering in the user interface of real world objects as object models based, at least in part, on a three-dimensional model corresponding to real world image data available for the current location, when retrieving the real world image data to the device via a wireless network, wherein the three-dimensional model has a lower resolution than the real world image data; and
initiating a presentation of a second rendering in the user interface of at least one of the real world objects based on retrieved real world image data, wherein the at least one of the real world objects is augmented with graphic elements of the real-time weather, traffic, or a combination thereof, when the retrieved real world image data does not correspond to the real-time weather, traffic, or a combination thereof at the current location.

3. A method of claim 2, further comprising:
determining a time period required to retrieve the real world image data, wherein the real world image data is derived from an optical real world image of the real world objects;
initiating a gradual transition of the user interface from the first rendering to the second rendering based, at least in part, on the time period; and
initiating a presentation of one or more intermediate renderings of one or more intermediate locations at a lower resolution based, at least in part, on the three-dimensional model with respect to a change in the current location of the device during the time period via vector imaging.

4. A method of claim 2, further comprising:
continuing the presentation of the first rendering in the user interface of the object models augmented with the graphic elements of the real-time weather, traffic, or a combination thereof.

5. A method of claim 2, wherein the context information further includes current time, date, season, holiday, activity, or a combination thereof at the current location of the device.

6. A method of claim 5, further comprising:
initiating an augmentation of graphic elements of the current time, date, season, holiday, activity, or a combination thereof into the first rendering, the second rendering, or a combination thereof.

7. A method of claim 2, wherein the real world image data includes one or more panoramic images, and the object models include three-dimensional outlines of the real world objects without facial details.

8. A method of claim 2, wherein the real world image data includes one or more panoramic images, and the object models includes one or more blurry low resolution pictures corresponding to the one or more panoramic images.

9. An apparatus comprising:
at least one processor; and
at least one memory including computer program code for one or more programs,
the at least one memory and the computer program code configured to, with the at least one processor, cause the apparatus embedded in a device to perform at least the following,
receive a request to render a user interface of a real world image from a location-based service, the request including location information;
determine context information associated with the device, a user of the device, or a combination thereof, wherein the context information includes real-time weather, traffic, or a combination thereof at a current location of the device;
initiate a presentation of a first rendering in the user interface of real world objects as object models based, at least in part, on a three-dimensional model corresponding to real world image data available for the current location, when retrieving the real world image data to the device via a wireless network, wherein the three-dimensional model has a lower resolution than the real world image data; and
initiate a presentation of a second rendering in the user interface of at least one of the real world objects based on retrieved real world image data, wherein the at least one of the real world objects is augmented with graphic elements of the real-time weather, traffic, or a combination thereof, when the retrieved real world image data does not correspond to the real-time weather, traffic, or a combination thereof at the current location.

10. An apparatus of claim 9, wherein the apparatus is further caused to:
determine a time period required to retrieve the real world image data, wherein the real world image data is derived from an optical real world image of the real world objects;
initiate a gradual transition of the user interface from the first rendering to the second rendering based, at least in part, on the time period; and
initiate a presentation of one or more intermediate renderings of one or more intermediate locations at a lower resolution based, at least in part, on the three-dimensional model with respect to a change in the current location of the device during the time period via vector imaging.

11. An apparatus of claim 9, wherein the apparatus is further caused to:
continue the presentation of the first rendering in the user interface of the object models augmented with the graphic elements of the real-time weather, traffic, or a combination thereof.

12. An apparatus of claim 9, wherein the context information further includes current time, date, season, holiday, activity, or a combination thereof at the current location of the device.

13. An apparatus of claim 12, wherein the apparatus is further caused to:
initiate an augmentation of graphic elements of the current time, date, season, holiday, activity, or a combination thereof into the first rendering, the second rendering, or a combination thereof.

14. An apparatus of claim 9, wherein the real world image data includes one or more panoramic images, and the object models include three-dimensional outlines of the real world objects without facial details.

15. An apparatus of claim 9, wherein the real world image data includes one or more panoramic images, and the object models includes one or more blurry low resolution pictures corresponding to the one or more panoramic images.

16. A non-transitory computer-readable storage medium carrying one or more sequences of one or more instructions which, when executed by one or more processors, cause an apparatus embedded in a device to at least perform the following steps:
receiving a request to render a user interface of a real world image from a location-based service, the request including location information;
determining context information associated with the device, a user of the device, or a combination thereof, wherein the context information includes real-time weather, traffic, or a combination thereof at a current location of the device;
initiating a presentation of a first rendering in the user interface of real world objects as object models based, at least in part, on a three-dimensional model corresponding to real world image data available for the current location, when retrieving the real world image data to the device via a wireless network, wherein the three-dimensional model has a lower resolution than the real world image data; and
initiating a presentation of a second rendering in the user interface of at least one of the real world objects based on retrieved real world image data, wherein the at least one of the real world objects is augmented with graphic elements of the real-time weather, traffic, or a combination thereof, when the retrieved real world image data does not correspond to the real-time weather, traffic, or a combination thereof at the current location.

17. A non-transitory computer-readable storage medium of claim 16, wherein the apparatus is caused to further perform:
determining a time period required to retrieve the real world image data, wherein the real world image data is derived from an optical real world image of the real world objects;
initiating a gradual transition of the user interface from the first rendering to the second rendering based, at least in part, on the time period; and
initiating a presentation of one or more intermediate renderings of one or more intermediate locations at a lower resolution based, at least in part, on the three-dimensional model with respect to a change in the current location of the device during the time period via vector imaging.

18. A non-transitory computer-readable storage medium of claim 16, wherein the apparatus is caused to further perform:
continuing the presentation of the first rendering in the user interface of the object models augmented with the graphic elements of the real-time weather, traffic, or a combination thereof.

19. A non-transitory computer-readable storage medium of claim 16, wherein the context information further includes current time, date, season, holiday, activity, or a combination thereof at the current location of the device.

20. A non-transitory computer-readable storage medium of claim 19, wherein the apparatus is caused to further perform:
initiating an augmentation of graphic elements of the current time, date, season, holiday, activity, or a combination thereof into the first rendering, the second rendering, or a combination thereof.

21. A non-transitory computer-readable storage medium of claim 16, wherein the real world image data includes one or more panoramic images, and the object models include three-dimensional outlines of the real world objects without facial details.
